(19) United States
(12) Patent Application Publication
(10) Pub. No.: US 2018/0157241 A1
(43) Pub. Date: Jun. 7, 2018

(54) ADJUSTMENT SYSTEM FOR MACHINING PARAMETER AND MACHINING PARAMETER ADJUSTMENT METHOD

(71) Applicant: INSTITUTE FOR INFORMATION INDUSTRY, TAIPEI (TW)

(72) Inventors: Jun-Ren CHEN, Taichung City (TW); Chih-Chieh LIN, Taipei City (TW); Hung-Sheng CHIU, Taipei City (TW); Hsiao-Chen CHANG, Taipei City (TW)

(21) Appl. No.: 15/604,674

(22) Filed: May 25, 2017

(30) Foreign Application Priority Data
Dec. 1, 2016 (TW) 105139737

(51) Int. Cl. G05B 19/4065; G05B 19/4155

(52) U.S. Cl. CPC G05B 19/4065; G05B 2219/37518; G05B 19/4155

(57) ABSTRACT

A adjustment system for machining parameter includes a storage device and a processor. The processor includes a mapping module and a prediction module. The mapping module determines a type of a tool under test. When the type of the tool under test is determined as the same as the type of the first cutting tool, the mapping module obtains the first machining data from the database and as it as a reference data of the tool under test. When a machining program related to at least one of the NC program blocks is going to be executed for the tool under test, the prediction module predicts a predicted capacity loss value of the tool under test at a predetermined PRM while executing the machining program.

### RELATED APPLICATIONS

This application claims priority to Taiwan Application Serial Number 105139737, filed Dec. 1, 2016, the entirety of which is herein incorporated by reference.

### BACKGROUND

### Technical Field

The present disclosure relates to an adjustment system for machining parameter and a machining parameter adjustment method. More particularly, the present disclosure relates to adjustment system for machining parameter and a machining parameter adjustment method applied to predicting a capacity loss value of a cutting tool.

### Description of Related Art

In general, in the machining process of the computer numerical control (CNC) machine, the cutting tool may affect the product quality, the manufacturing cost, and so on. Therefore, the replacement or the maintenance of the cutting tool is non-ignorable in the machining process. However, in the process of replacing the cutting tool, is has to switch off the machine, disassemble the old cutting tool, and assemble a new cutting tool. Then, the machine is witched on, and warmed up until it is able to work normally. It can be seen that the capacity will be affected if the frequency of the replacement of the cutting tool is too high. Moreover, if the cutting tool is not replaced in a moment when it gets worn, the product quality may get worse due to the incorrect machining precision of the cutting tool.

Therefore, if it is able to precisely estimate the wear condition of the cutting tool, the machining process will get smoother. For example, the cutting tool is replaced in a moment before the machining precision of the cutting tool is incorrect due to excessive wear. Accordingly, how to precisely estimate the capacity loss value of the cutting tool has become a problem to those skilled in the art.

### SUMMARY

To address the issues, one aspect of the present disclosure is to provide an adjustment system for machining parameter including a storage device and a processor. The storage device is configured for storing a database. The database is configured for storing a first machining data corresponding to a first cutting tool. The first machining data includes a type of the first cutting tool, a plurality of NC program blocks, and a plurality of known capacity values of loss of each of the NC (Numerical control) program blocks at a plurality of known RPMs (revolution per minute), respectively. The processor is coupled to the storage device. The processor includes a mapping module and a prediction module. The mapping module is configured for determining a type of a tool under test. When the type of the tool under test is determined as the same as the type of the first cutting tool, the mapping module obtains the first machining data from the database and refers to the first machining data as a reference data of the tool under test. When a machining program related to at least one of the NC program blocks is going to be executed for the tool under test, the prediction module is configured for predicting a predicted capacity loss value of the tool under test at a predetermined PRM while executing the machining program, according to the known capacity loss value of the at least one of the NC program blocks, to which the reference data is related, at the known RPM (revolution per minute).

Another aspect of the present disclosure is to provide a machining parameter adjustment method including: storing a first machining data corresponding to a first cutting tool, wherein the first machining data includes a type of the first cutting tool, a plurality of NC program blocks, and a plurality of known capacity values of loss of each of the NC program blocks at a plurality of known RPMs, respectively; determining a type of a tool under test by a mapping module, obtaining the first machining data from the database, and referring to the first machining data as a reference data of the tool under test when the type of the tool under test is determined as the same as the type of the first cutting tool; and when a machining program related to at least one of the NC program blocks is going to be executed for the tool under test, predicting a predicted capacity loss value of the tool under test at a predetermined PRM by a prediction module while executing the machining program, according to the known capacity values of loss of the at least one of the NC program blocks, to which the reference data is related, at the known RPM.

As mentioned above, the adjustment system for machining parameter and the machining parameter adjustment method of the present disclosure are able to precisely estimate the depreciation of the tool under test, by predicting a predicted capacity loss value of the tool under test at the predetermined rotational while executing the machining program. Therefore, it is able to adjust the rotational speed of the machining at a moment before the cutting tool is unable to use due to excessive wear, so as to extend the operating life of the cutting tool and maintain the cutting quality.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 depicts a block diagram of an adjustment system for machining parameter according to one embodiment of present disclosure;

FIG. 2 depicts a flowchart of a machining parameter adjustment method according to one embodiment of the present disclosure;

FIG. 3 depicts a schematic diagram of a machining program according to one embodiment of the present disclosure; and

FIG. 4 depicts a block diagram of an adjustment system for machining parameter according to one embodiment of present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

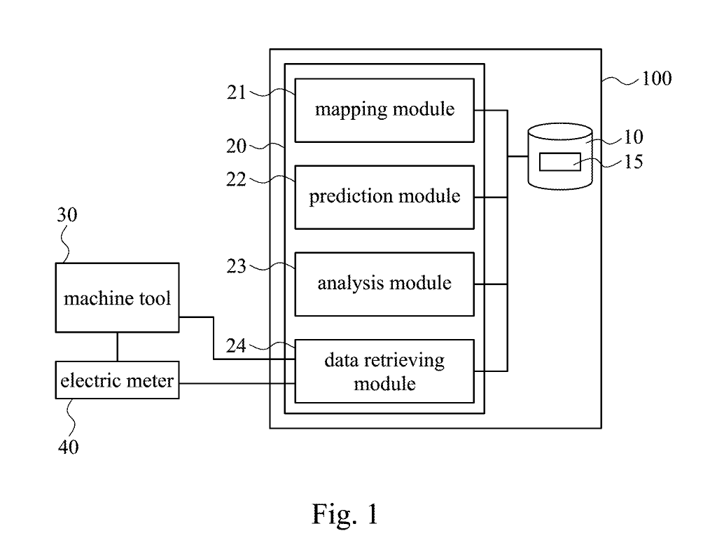

Reference is made to FIG. 1. FIG. 1 depicts a block diagram of an adjustment system for machining parameter 100 according to one embodiment of present disclosure. In one embodiment, the adjustment system for machining parameter 100 includes a storage device 10 and a processor 20. In one embodiment, the adjustment system for machining parameter 100 may be a personal computer, an industrial computer, a server, or other electronic device.

In one embodiment, the storage device 10 can be implemented by using a ROM (read-only memory), a flash memory, a floppy disc, a hard disc, an optical disc, a flash disc, a tape, an database accessible from a network, or any storage medium with the same functionality that can be contemplated by persons of ordinary skill in the art to which this invention pertains.

In one embodiment, the processor 20 is configured for executing various computations, and is implemented as a microcontroller, a microprocessor, a digital signal processor, an application specific integrated circuit (ASIC), or a logic circuit.

In one embodiment, the processor 20 is coupled to the storage device 10. In one embodiment, the processor 20 includes a mapping module 21, a prediction module 22, an analysis module 23, and a data retrieving module 24, which are respectively or jointly implemented as a microcontroller, a microprocessor, a digital signal processor, an application specific integrated circuit (ASIC), or a logic circuit.

In one embodiment, the data retrieving module 24 is electrically coupled to a machine tool 30. The machine tool 30 includes at least one type of the cutting tool configured for cutting the workpiece. In one embodiment, the machine tool 30 is able to replace the cutting tool for cutting. In one embodiment, the machine tool 30 is, for example, FANUC machine, MITSUBISHI machine, HEIDENHAIN machine, SIEMENS machine, and so on.

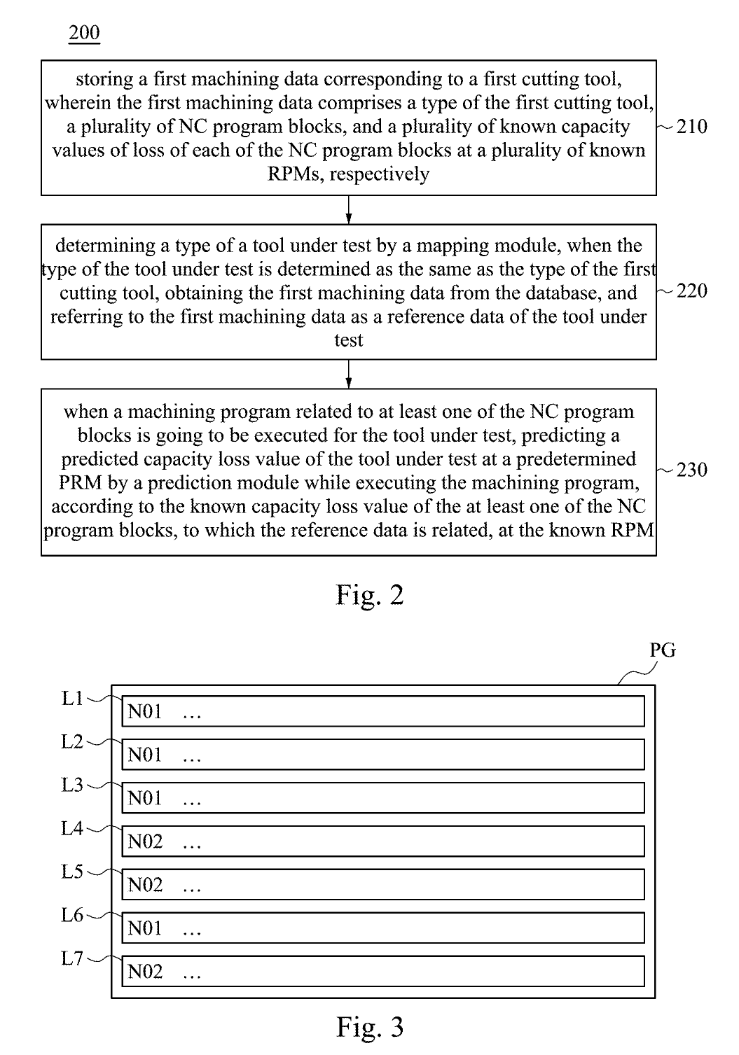

The machining parameter adjustment method 200 is described as below. For conveniently describing it, reference is made to FIG. 1 with FIG. 2 and FIG. 3. FIG. 2 depicts a flowchart of a machining parameter adjustment method 200 according to one embodiment of the present disclosure. FIG. 3 depicts a schematic diagram of a machining program PG according to one embodiment of the present disclosure.

In operation 210, the storage device 10 is configured for storing a database 15. The database 15 is configured for storing a first machining data corresponding to a first cutting tool. The first machining data includes a type of the first cutting tool, a plurality of NC (Numerical control) program blocks corresponding to the first cutting tool, and a plurality of known capacity values of loss of each of the NC program blocks at a plurality of known RPMs, respectively. Furthermore, the database 15 is further configured for storing a total capacity value of the first cutting tool, i.e., the total pieces of product that the first cutting tool is able to produce on the condition that the machining precision is correct. It is noted that the total pieces of product is a practical total capacity value. In other words, the rotational speed of the first cutting tool is able to be adjusted by comparing the practical total capacity value of the first cutting tool with the practical total capacity value of a second cutting tool at different rotational speeds (e.g., the feed speed).

For example, when 5000 pieces of product are produced, the NC program block is executed 5000 times (on the condition that every time one piece of product is produced, the NC program block is executed once). Then, the capacity loss value of the NC program block is 5000/5000=1 piece/time. For another example, when 5000 pieces of product are produced, the NC program block is executed 10000 times (on the condition that every time one piece of product is produced, the NC program block is executed twice). Then, the capacity loss value of the NC program block is 5000/10000=0.5 piece/time.

In one embodiment, the database 15 stores that the capacity loss value of the known first cutting tool (e.g., the flat end mill) at the spindle speed of 6000 RPM (Revolutions Per minute) while executing a specific NC program block for this cutting tool is 0.5 piece/time (regarded as the known capacity loss value). In other words, it represents that every time the specific NC program block is executed, the capacity loss value of the first cutting tool at the spindle speed of 6000 RPM is 0.5 piece/time.

In one embodiment, the database 15 stores that an idle load of the known first cutting tool is 10 KW-50 KW on the condition that the first cutting tool is idle, and a machining load of the known first cutting tool is 50 KW-120 KW on the condition that the first cutting tool cuts.

In one embodiment, the database 15 stores that the capacity loss value of the known first cutting tool at the feed speed of 3×10⁶ RPM (high feed speed mode) while executing the specific NC program block for this cutting tool is 0.8 piece/time (regarded as the known capacity loss value). Moreover, the capacity loss value of the first cutting tool at the feed speed of 6000 RPM is 0.5 piece/time (regarded as the known capacity loss value) while executing the specific NC program block for this cutting tool.

In one embodiment, by practically putting each cutting tool into a machine tool 30, performing machining at different rotational speeds, and measuring the machining results, the aforementioned capacity loss values are obtained.

In one embodiment, the database 15 stores a plurality of machining data corresponding to a plurality of known cutting tools (e.g., the first cutting tool and the second cutting tool). In one embodiment, the data retrieving module 24 is configured for obtaining all information from the machine tool 30 while the machine tool 30 works.

In one embodiment, the analysis module 23 is configured for obtaining the first machining data corresponding to the first cutting tool via the data retrieving module 24. The first machining data further includes an electric quantity information.

In one embodiment, the analysis module 23 is configured for obtaining a second machining data corresponding to a second cutting tool (e.g., the ball end mill), and storing the second machining data in the database 15.

In one embodiment, the data retrieving module 24 reads the machining program PG from the machine tool 30 and executing the machining program PG. A plurality of the NC program blocks includes a first instruction and a second instruction which are corresponding to different known capacity values of loss.

As shown in FIG. 3, the machining program PG includes the NC program blocks L1-L7, in which the NC program blocks L1-L3 and L6 includes the same instruction content, called as the first instruction, and the NC program blocks L4-L5 and L7 includes the same another instruction content, called as the second instruction.

In one embodiment, the known capacity loss value of the first cutting tool at the rotational speed of 6000 RPM while executing the first instruction is 0.5 piece/time, and the known capacity loss value of the first cutting tool at the rotational speed of 6000 RPM while executing the second instruction is 0.3 piece/time. These data are stored in the database 15.

In one embodiment, the analysis module 23 is able to calculate the number of times the first instruction (e.g., the NC program blocks L1-L3 and L6) and/or the second instruction (e.g., the NC program blocks L4-L5 and L7) are executed. For example, after finishing the execution of the machining program PG, the first instruction is executed four times (since each of the NC program blocks L1-L3 and L6 is executed once) and the second instruction is executed thrice (since each of the NC program blocks L4-L5 and L7 is executed once).

In one embodiment, it is supposed that the database 15 records that the capacity loss value of the first cutting tool at the spindle speed of 6000 RPM is 0.5 piece/time while executing the first instruction. The total pieces of product is 5000 (this is known information stored in the database 15), which the first cutting tool is able to produce on the condition that the machining precision is correct at beginning. This represents that when the number of times the first instruction is executed for the first cutting tool exceeds 10000, the machining precision of the first cutting tool may get worse, even the first cutting tool may be broken. In other words, since the capacity loss value of the first cutting tool at the spindle speed of 6000 RPM is 0.5 piece/time while executing the first instruction, the machining precision of the first cutting tool may begin to get worse or the first cutting tool may be broken when the first instruction is executed 10000 times.

Accordingly, the adjustment system for machining parameter 100 is able to effectively estimate the time point when the cutting tool is broken, and substitute another one for the cutting tool which is going to be broken.

In one embodiment, the data retrieving module 24 reads the machining program PG from the machine tool 30 and executing the machining program PG. Each of the NC program blocks is corresponding to different known capacity values of loss at different know rotational speeds, respectively.

In one embodiment, the known capacity values of loss are obtained by practically putting each cutting tool into the machine tool 30, performing machining at different rotational speeds, and measuring the machining results. Therefore, after the data retrieving module 24 reads the machining program PG from the machine tool 30, the analysis module 23 is able to analyze what the type and the number of the NC program blocks that the machining program PG includes (e.g., 4 first instructions and 3 second instructions), and obtain the different known capacity values of loss of the first cutting tool corresponding to each of the NC program blocks at different known RPMs from the database 15. For example, the known capacity loss value at the known RPM of 6000 RPM while executing a specific machining program is 0.5 piece/time. For another example, the known capacity loss value at the known RPM of 8000 RPM while executing a specific machining program is 0.6 piece/time.

In one embodiment, the known RPMs include a test spindle RPM and a test fed speed. The data retrieving module 24 reads the electric quantity information from an electric meter 40. The electric quantity information includes an idle load and a machining load corresponding to the first cutting tool while executing each of the NC program blocks for the first cutting tool.

In one embodiment, the analysis module 23 is further configured for determining whether the first cutting tool is idle according to the electric quantity information corresponding to each of the NC program blocks when the first cutting tool is operated at the test spindle RPM and the test feed speed.

For example, via the electric quantity information, it can be seen that a ratio of the idle load (e.g. 10 KW-50 KW) to the machining load (e.g., 50 KW-120 KW) of the first cutting tool, which is operated at the spindle speed and the feed speed, while executing the plural of the first instructions, e.g., 50% of the numbers of times the first instruction is executed is used as idle, and 50% of the numbers of times the first instruction is executed is used as cutting.

By analyzing the power consumption of the load, it can be seen whether these first instructions and/or second instructions are executed in the machining mode (the cutting tool gets worn due to machining). Once they are analyzed as in the machining (no idle) mode, the number of times the instruction is executed is accumulated. More specifically, when the cutting tool is inserted, extracted, or moved, the idling happens. If the number of times of the machining is accumulated on this condition, it loses the accuracy. Moreover, whatever the rotational speed is, inserting or extracting the cutting tool is not affected. Therefore, the idling is irrelevant to the rotational speed.

By the aforementioned method, the analysis module 23 is able to analyze the capacity loss values corresponding to various types of the cutting tool at various rotational speeds while executing each of the NC program blocks (for example, the known capacity values of loss of the first cutting tool at the rotational speed of 6000 RPM while executing one first instruction is 0.5 piece/time, and the known capacity values of loss of the first cutting tool at the rotational speed of 6000 RPM while executing one second instruction is 0.3 piece/time; for another example, the known capacity values of loss of the first cutting tool at the rotational speed of 4000 RPM while executing one first instruction is 0.3 piece/time, and the known capacity values of loss of the first cutting tool at the rotational speed of 4000 RPM while executing one second instruction is 0.2 piece/time; for a further example, the known capacity values of loss of the first cutting tool at the rotational speed of 8000 RPM while executing one first instruction is 0.6 piece/time, and the known capacity values of loss of the first cutting tool at the rotational speed of 8000 RPM while executing one second instruction is 0.4 piece/time.), and stores these data in the database 15.

In operation 220, the mapping module 21 is configured for determining a type of a tool under test. When the type of the tool under test is determined as the same as the type of the first cutting tool, the mapping module 21 obtains the first machining data from the database 15 and refers to the first machining data as a reference data of the tool under test.

When the user wants to predict a predicted capacity loss value of the tool under test (e.g., a new cutting tool), it is able to determine the predicted capacity loss value in according with the machining data in the database 15.

For example, when the mapping module 21 determines that the type of the tool under test is the same as the type of the first cutting tool (e.g., both are the flat end mill), the mapping module 21 obtains the first machining data from the database 15 and refers to the first machining data as the reference data of the tool under test.

Since the type of the tool under test is the same as the type of the first cutting tool, the tool under test should have the same or similar capacity loss value when the tool under test is operated at the same rotational speed and cuts the same workpiece (e.g., producing the wheel rim likewise) as the first cutting tool. Accordingly, the reference data is configured for predicting the operating life of the tool under test. For example, the first cutting tool, which is operated at the specific rotational speed while executing the machining program, may be broken when the number of times the cutting tool cuts is greater than 1000. By this information, it is able to predict that the tool under test, which is operated at the same specific rotational speed whole executing the same machining program, similarly may be broken when the number of times the to-be tested cutting cuts is greater than 1000, which results that the product quality is bad. Therefore, the user can prepare to replace the cutting tool or lower the rotational speed in advance.

In one embodiment, when the mapping module 21 determines that the type of the tool under test is the same as the type of the second cutting tool, the mapping module 21 obtains the second machining data from the database 15 and as the second machining data as the reference data of the tool under test. For example, when the mapping module 21 determines that the type of the tool under test is the same as the type of the second cutting tool (e.g., both are the ball end mill), the mapping module 21 obtains the second machining data from the database 15 and as the second machining data as the reference data of the tool under test.

In operation 230, when a machining program related to at least one of the NC program blocks is going to be executed for the tool under test, the prediction module 22 is configured for predicting a predicted capacity loss value of the tool under test at a predetermined PRM while executing the machining program, according to the known capacity loss value of the at least one of the NC program blocks, to which the reference data is related, at the known RPMs.

In one embodiment, the first machining data stored in the database 15 includes: the known capacity loss value of the first cutting tool at the rotational speed of 6000 RPM while executing the first instruction is 0.5 piece/time, and the known capacity loss value of the first cutting tool at the rotational speed of 6000 RPM while executing the second instruction is 0.3 piece/time. When the mapping module 21 determines that the type of the tool under test is the same as the type of the first cutting tool, the mapping module 21 obtains the second machining data from the database 15 and as the second machining data as the reference data of the tool under test. If the machining program includes total 14 instructions and these 14 instructions includes 4 the first instructions and 10 the second instructions, the prediction module 22 is able to calculate and predict the predicted capacity loss value of the tool under test at the rotational speed of 6000 RPM while executing one machining program is 5 piece/time (i.e., 0.5×4+0.3×10=5).

In other words, in the above-mentioned example, it is supposed that the mapping module 21 determines that the to-be test cutting tool is able to produce at most 50000 pieces of product from the beginning until it is broken according to the reference data. Since the predicted capacity loss value of the tool under test at the rotational speed of 6000 RPM while executing one machining program is 5 piece/time, the prediction module 22 is able to extrapolate that the total pieces of product, which the tool under test produces, will exceed 50000 when the number of times the machining program is executed for the tool under test exceeds 10000. As a result, the machining precision of the tool under test may get worse or the tool under test may be broken due to the wear.

In one embodiment, when the mapping module 21 determines that the type of the tool under test is the same as the type of the first cutting tool, the prediction module 22 obtains the test spindle RPM and the test feed speed of the first cutting tool, which are corresponding to a current spindle speed and a current feed speed of the tool under test, respectively, from the database 15, and looks up one of the known capacity values of loss corresponding to the test spindle RPM and the test feed speed of the first cutting tool, so as to predict the predicted capacity loss value of the tool under test.

For example, when the mapping module 21 determines that the type of the tool under test is the same as the type of the first cutting tool, the prediction module 22 obtains the test spindle RPM of 5000 RPM and the test feed speed of 3×10⁶ RPM of the first cutting tool, which are corresponding to a current spindle speed of 5000 RPM and a current feed speed of 3×10⁶ RPM of the tool under test, respectively, from the database 15, and looks up the known capacity values of loss corresponding to the test spindle RPM and the test feed speed of the first cutting tool, which is 0.8 piece/time, so as to predict that the predicted capacity loss value of the tool under test is 0.8 piece/time.

Therefore, the prediction module 22 is able to predict the predicted capacity loss value of the tool under test by accumulating the capacity loss value corresponding to each instruction.

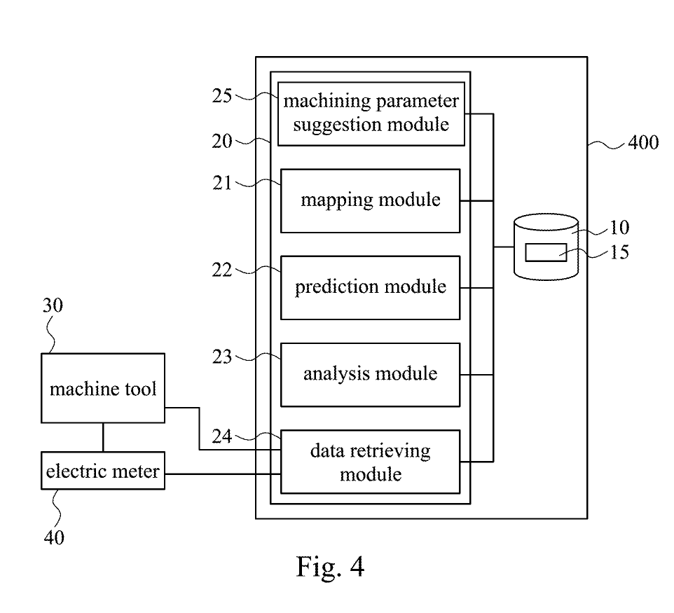

Reference is made to FIG. 4. FIG. 4 depicts a block diagram of an adjustment system for machining parameter 400 according to one embodiment of present disclosure. The difference between the adjustment system for machining parameter 400 of the FIG. 4 and the adjustment system for machining parameter 100 of the FIG. 1 is that the adjustment system for machining parameter 400 further includes a machining parameter suggestion module 25. The machining parameter suggestion module 25 is coupled to the mapping module 21 and the database 15. In one embodiment, the machining parameter suggestion module 25 is implemented as a microcontroller, a microprocessor, a digital signal processor, an application specific integrated circuit (ASIC), or a logic circuit.

In one embodiment, the machining parameter suggestion module 25 is configured for obtaining at least one suggested machining parameter corresponding to the tool under test from the database 15 when the predicted capacity loss value is less than a capacity threshold. The at least one suggested machining parameter is configured for adjusting at least one of the current spindle speed and the current feed speed.

For example, it is supposed that the predicted capacity loss value of the tool under test at the current spindle speed of 3000 RPM and the current feed speed of 8000 RPM while executing the machining program is 0.6 piece/time. If the capacity threshold stored in the database 15 on the same operating condition is 0.65 piece/time, it represents that the tool under test should enhance the predicted capacity loss by adjusting the rotational speed to enhance the speed of producing the workpiece. Accordingly, the machining parameter suggestion module 25 obtains at least one suggested machining parameter (e.g., the rotational speed parameter) corresponding to the tool under test from the database 15 to adjust at least one of the current spindle speed (e.g., adjusted as 4000 RPM) and the current feed speed (e.g., adjusted as 9000 RPM). Accordingly, on the condition that the number of times the NC program blocks are executed is the same, the number of the wheel rims that the to-be tested is predicted to produce is from 600 to 650 by adjusting the rotational parameter.

As mentioned above, the adjustment system for machining parameter and the machining parameter adjustment method of the present disclosure are able to precisely estimate the depreciation of the tool under test, by predicting a predicted capacity loss value of the tool under test at the predetermined rotational while executing the machining program. Therefore, it is able to adjust the rotational speed of the machining at a moment before the cutting tool is unable to use due to excessive wear, so as to extend the operating life of the cutting tool and maintain the product quality.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An adjustment system for machining parameter, comprising:
a storage device configured for storing a database, the database configured for storing a first machining data corresponding to a first cutting tool, wherein the first machining data comprises a type of the first cutting tool, a plurality of NC (Numerical control) program blocks, and a plurality of known capacity values of loss of each of the NC program blocks at a plurality of known RPMs (revolution per minute), respectively;
a processor coupled to the storage device, wherein the processor comprises:
a mapping module configured for determining a type of a tool under test, wherein when the type of the tool under test is determined as the same as the type of the first cutting tool, the mapping module obtains the first machining data from the database, and refers to the first machining data as a reference data of the tool under test; and
a prediction module, wherein when a machining program related to at least one of the NC program blocks is going to be executed for the tool under test, the prediction module is configured for predicting a predicted capacity loss value of the tool under test at a predetermined PRM while executing the machining program, according to the known capacity loss value of the at least one of the NC program blocks, to which the reference data is related, at the known RPMs.

2. The adjustment system for machining parameter of claim 1, wherein the processor further comprises:
an analysis module configured for obtaining a second machining data corresponding to a second cutting tool from the database and storing the second machining data in the database,
wherein when the mapping module determines that the type of the tool under test is the same as a type of the second cutting tool, the mapping module obtains the second machining data from the database, as the second machining data as the reference data of the tool under test.

3. The adjustment system for machining parameter of claim 1, wherein the processor further comprises:
an analysis module configured for obtaining the first machining data corresponding to the first cutting tool via a data retrieving module,
wherein the first machining data further comprises an electric quantity information.

4. The adjustment system for machining parameter of claim 3, wherein the data retrieving module reads the machining program from a machine tool and executes the machining program, wherein the NC program blocks comprises a first instruction and a second instruction which are corresponding to the different known capacity values of loss.

5. The adjustment system for machining parameter of claim 3, wherein the data retrieving module reads the machining program from a machine tool and executes the machining program, wherein each of the NC program blocks is corresponding to the different known capacity loss value at the different known RPMs.

6. The adjustment system for machining parameter of claim 3, wherein the known RPMs comprise a test spindle RPM and a test feed speed, wherein the data retrieving module reads the electric quantity information from an electric meter, and the electric quantity information comprises an idle load and a machining load which are corresponding to the first cutting tool while executing the NC program blocks,
wherein the analysis module is further configured for determining whether the first cutting tool is idle according to the electric quantity information corresponding to the NC program blocks when the first cutting tool is operated at the test spindle RPM and the test feed speed.

7. The adjustment system for machining parameter of claim 6, wherein when the mapping module determines that the type of the tool under test is the same as the type of the first cutting tool, the prediction module obtains the test spindle RPM and the test feed speed of the first cutting tool, which are corresponding to a current spindle speed and a current feed speed of the tool under test, respectively, from the database, and looks up one of the known capacity values of loss corresponding to the test spindle RPM and the test feed speed of the first cutting tool, so as to predict the predicted capacity loss value of the tool under test.

8. The adjustment system for machining parameter of claim 7, wherein the processor further comprises:
a machining parameter suggestion module configured for obtaining at least one suggested machining parameter corresponding to the tool under test from the database when the predicted capacity loss value is less than a capacity threshold, wherein the at least one suggested machining parameter is configured for adjusting at least one of the current spindle speed and the current feed speed.

9. A machining parameter adjustment method, comprising:
storing a first machining data corresponding to a first cutting tool, wherein the first machining data comprises a type of the first cutting tool, a plurality of NC program blocks, and a plurality of known capacity values of loss of each of the NC program blocks at a plurality of known RPMs, respectively;
determining a type of a tool under test by a mapping module, when the type of the tool under test is determined as the same as the type of the first cutting tool, obtaining the first machining data from the database, and referring to the first machining data as a reference data of the tool under test; and
when a machining program related to at least one of the NC program blocks is going to be executed for the tool under test, predicting a predicted capacity loss value of the tool under test at a predetermined PRM by a prediction module while executing the machining program, according to the known capacity loss value of the at least one of the NC program blocks, to which the reference data is related, at the known RPM.

10. The machining parameter adjustment method of claim 9, further comprising:
obtaining a second machining data corresponding to a second cutting tool from the database by an analysis module and storing the second machining data in the database,
wherein when the mapping module determines that the type of the tool under test is the same as a type of the second cutting tool, the mapping module obtains the second machining data from the database, and as the second machining data obtaining from the database as the reference data of the tool under test.

11. The machining parameter adjustment method of claim 9, further comprising:
obtaining the first machining data corresponding to the first cutting tool via a data retrieving module by an analysis module, wherein the first machining data further comprises an electric quantity information.

12. The machining parameter adjustment method of claim 9, further comprising:
reading the machining program from a machine tool and executing the machining program, wherein the NC program blocks comprises a first instruction and a second instruction which are corresponding to the different known capacity values of loss.

13. The machining parameter adjustment method of claim 9, reading the machining program from a machine tool and executing the machining program, wherein each of the NC program blocks is corresponding to the different known capacity loss value at the different known RPMs.

14. The machining parameter adjustment method of claim 11, wherein the known RPMs comprise a test spindle RPM and a test feed speed, wherein the data retrieving module reads the electric quantity information from an electric meter, and the electric quantity information comprises an idle load and a machining load which are corresponding to the first cutting tool while executing the NC program blocks,
wherein the machining parameter adjustment method further comprises:
determining whether the first cutting tool is idle by the analysis module according to the electric quantity information corresponding to the NC program blocks when the first cutting tool is operated at the test spindle RPM and the test feed speed.

15. The machining parameter adjustment method of claim 14, further comprising:
when the mapping module determines that the type of the tool under test is the same as the type of the first cutting tool, obtaining the test spindle RPM and the test feed speed of the first cutting tool, which are corresponding to a current spindle speed and a current feed speed of the tool under test, respectively, from the database by the prediction module; and
looking up one of the known capacity values of loss corresponding to the test spindle RPM and the test feed speed of the first cutting tool by the prediction module, so as to predict the predicted capacity loss value of the tool under test.

16. The machining parameter adjustment method of claim 15, further comprising:
obtaining at least one suggested machining parameter corresponding to the tool under test from the database by a machining parameter suggestion module when the predicted capacity loss value is less than a capacity threshold, wherein the at least one suggested machining parameter is configured for adjusting at least one of the current spindle speed and the current feed speed.
